(19) United States
(12) Patent Application Publication
(10) Pub. No.: US 2003/0158954 A1
(43) Pub. Date: Aug. 21, 2003

(54) Software-defined radio communication protocol translator

(76) Inventor: Terry L. Williams, Melbourne, FL (US)

Correspondence Address: Robert J. Sacco, Akerman, Senterfitt & Eidson, P.A., Post Office Box 3188, West Palm Beach, FL, 33402-3188, US

(21) Appl. No.: 10/078,783

(22) Filed: Feb. 19, 2002

(51) Int. Cl. G06F 15/16

(52) U.S. Cl. 709/230; 709/246

(57) ABSTRACT

A method and apparatus for facilitating communications between communications systems operating on different communications protocols. The process involves receiving a first communication signal, translating the communication signal from a first protocol to a second protocol, and re-transmitting the communication signal. The communications protocols can include at least one of a data format, data timing system, coding scheme, transmission mode, and carrier frequency. A software-defined translator can be configured for receiving the communication signal, performing the protocol translation, and re-transmitting the communication signal.

### BACKGROUND OF THE INVENTION

1. Technical Field

The invention relates generally to radio communications. More particularly, the invention relates to radio communication software defined translators.

2. Description of the Related Art

Interoperability of agency communications systems has become an important issue for local, state and federal governments. Different government and public safety agencies, such as police and fire departments and emergency medical services, often utilize different radio communication systems, operate in different frequency bands, and use different communication protocols. Therefore, when a disaster or some event occurs, coordination between agencies becomes difficult because these agencies are not able to effectively communicate with one another.

To work around frequency and protocol incompatibilities, agencies have developed a variety of “low tech” inter-agency communication methods, which include using walkie-talkies and scanners, posting representatives in dispatch centers to relay information, and issuing mobile radios to other agencies. In order to improve interoperability of agency communications, the Association of Public Safety Communications Officials International (APCO) initiated “Project 25” to establish a standards profile for the operations and functionality of new digital Public Safety radio systems.

The standards profile generated by Project 25 requires agencies to upgrade existing communications equipment to improve interoperability between agencies, including mobile communication devices in public safety vehicles. But implementation of the upgrades is anticipated to be costly and will likely take time to fully implement. Limitations in funding are preventing many government and public safety agencies from upgrading their existing communications equipment. Hence, without some other solution these agencies will continue to communicate in different frequency bands using different communication protocols for some time, which will result in continued limitations on the ability of these agencies to handle different types of interoperability situations. Accordingly, what is needed is a device that enables interoperation between different communication systems, especially those using different frequency bands and/or different communication protocols.

### SUMMARY OF THE INVENTION

The invention concerns a method and system for use in a communications environment comprised of a plurality of communications systems, where each communication system has a distinct communications protocol associated therewith. The method facilitates inter-system communications using a software-defined translator. The method begins by selecting from among a plurality of predefined software communication protocol applications available in the software-defined translator, a plurality of correlating communication protocols applications respectively corresponding to a plurality of the communications protocols in use by the communication systems. The correlating communications protocols applications are then instantiated in the software-defined translator. Once the system has been configured in this manner, the process can continue by receiving a first communication transmitted by a first one of the plurality of communication systems corresponding to a first one of the plurality of communications protocols. The first communication can then be translated to at least a second one of the plurality of communications protocols. Finally, the communication can be retransmitted after the translation step. The translating can also include translating the first communication to a common protocol prior to translation to the second one of the plurality of communications protocols. If necessary in a particular situation, the communication can be translated to a plurality of the communications protocols in use by the communications systems. Each of the communications protocols as referenced herein can be comprised of a data format, data timing system, coding scheme, transmission mode, carrier frequency or any other specification necessary for communicating using a particular communication system.

According to one aspect of the invention, the receiving step can also include the step of receiving the first communication at a repeater station and then forwarding the first communication to the software defined translator. Similarly, the re-transmitting step can further include forwarding the first communication to a repeater station for re-transmitting.

According to another aspect, the invention can include the step of backhauling the first communication from the software-defined translator to a base station prior to the re-transmitting step. The process can also include forwarding the first communication from the base station to a second software-defined translator prior to the re-transmitting step.

The invention also concerns a software defined translator system. The system can include an interactive management interface. The interface is responsive to a user input for instantiating in a software-defined translator a plurality of correlating communication protocol applications respectively corresponding to a plurality of the communications protocols in use by the communication systems. The software defined translator system can be responsive to a first communication transmitted by a first one of the plurality of communications systems in accordance with a first one of the plurality of communications protocols. More particularly, the software defined translator system can translate the first communication to at least a second one of the plurality of communication protocols, and re-transmit the first communication after the translation process. Advantageously, the software-defined translator can translate the first communication to a common protocol prior to translation to the second one of the plurality communications protocols. Further, the software-defined translator can translate the first communication to a plurality of the communications protocols prior to retransmission of the same. In that case, the software defined translator can include suitable a suitable transmitter apparatus for retransmitting the first communication in accordance with each the plurality of communications protocols.

As with the inventive method, a repeater station can be used for receiving the first communication and forwarding the first communication over a backhaul link to the software defined translator. The repeater station can be used for receiving the first communication from the software-defined translator over a backhaul link after the first communication has been translated.

A backhaul link can also be provided for backhauling the first communication from the software-defined translator to a base station prior to the retransmission. Finally, a second backhaul link can be provided for backhauling the first communication from the base station to a second translator prior to the retransmission.

### BRIEF DESCRIPTION OF THE DRAWINGS

There are presently shown in the drawings embodiments, which are presently preferred, it being understood, however, that the invention is not limited to the precise arrangements and instrumentalities shown.

FIG. 1 shows a simplified block diagram of a software-defined translator incorporating protocol translation.

FIG. 2A shows a simplified block diagram of software-defined transceiver.

FIG. 2B shows a simplified block diagram of DSPs contained in a DSP module.

FIG. 3A is a flow chart relating to user selection of communications protocols for particular software-defined radio transceivers.

FIG. 3B is a flow chart relating to operation of a software defined translator incorporating software defined radio components that is useful for illustrating the method of providing protocol translation for selected software defined radio transceivers.

FIG. 4A is a flow chart relating to user selection of communications protocols for particular communications links.

FIG. 4B is a flow chart relating to operation of a software-defined translator incorporating software-defined radio components that is useful for illustrating the method of providing protocol translation for selected communications links.

FIG. 5 shows a shows a simple diagram of a communications network incorporating mobile communication devices, repeaters, and a software-defined translator incorporating protocol translation.

### DETAILED DESCRIPTION OF THE PREFERRED EMBODIMENT

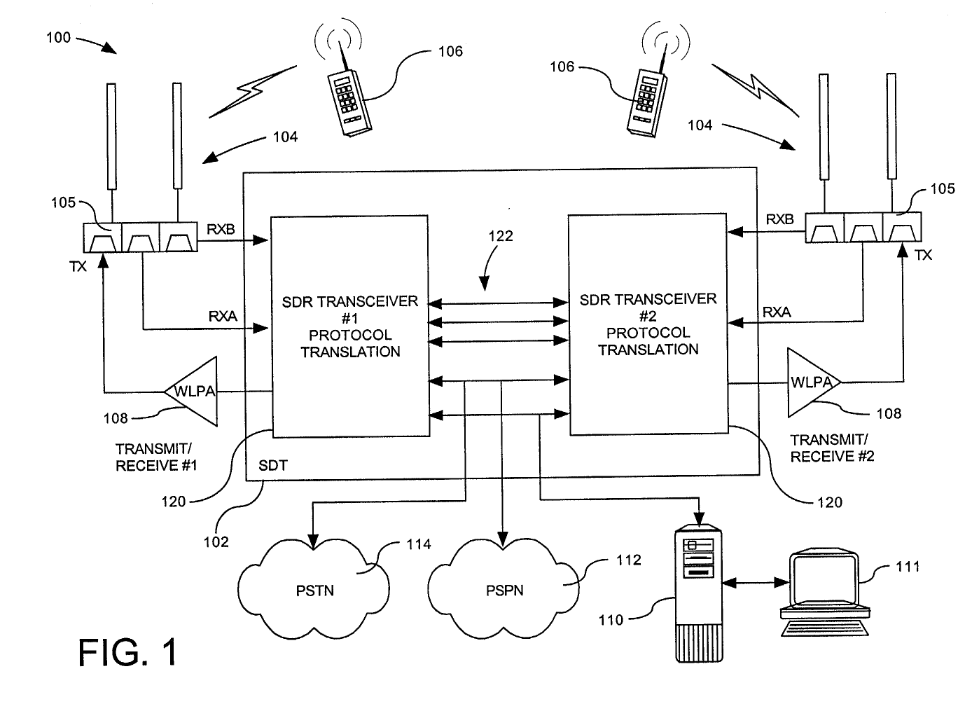

FIG. 1 is a block diagram of a mobile communications network 100 incorporating a software-defined translator (SDT) 102 and mobile communication devices 106. Mobile communication devices 106 can be configured for voice or data communication and can operate using any of a wide variety of known and proprietary communication protocols. Generally, the SDT 102 can facilitate communication among mobile communication devices 106 and between mobile communication devices 106 and other data networks, for example a public switched telephone network (PSTN) 114 or a public switched packet network (PSPN) 112. This is accomplished by receiving a communication in accordance with a first communications protocol, translating the communication to a common internal protocol, and then re-transmitting the communication in accordance with a second communications protocol.

SDT can incorporate at least one of each of an antenna 104 that may be comprised of an array, duplexer 105, wideband linear power amplifier (WLPA) 108, and software defined radio (SDR) transceiver 120. Two sets of SDR transceivers 120, WLPAs 108, duplexers 105 and antennas 104 are shown in FIG. 1 for exemplary purposes, however the invention is not thus limited. For example, one SDR transceiver can be used, or many SDR transceivers can be used.

The term software defined radio (SDR) as used herein describes software control of a variety of radio communication operating parameters; for example, frequency, modulation techniques, communications security functions, and waveform requirements. The fact that these parameters are determined by software means that SDR transceivers 120 can be programmed to transmit and receive on any frequencies and to use any desired transmission modulation, coding and information formats within the limits of its design, affording the system substantial flexibility to communicate with multiple radio services. The SDR transceivers 120 can perform signal processing in the digital domain enabling the operating parameters of the SDR transceivers 120 to be selected and dynamically altered in the field. Further, each SDR 120 translates received communications to a common internal protocol and can convert communications in the form of the common internal protocol to a different protocol for re-transmission.

Communication signals transmitted to the SDT 102 from RF sources, for example mobile communication devices 106, can be received by an antenna array 104, and sent through a duplexer 105 to an RF input of an SDR transceiver 120. The duplexer 105 enables the antenna array 104 to transmit and receive communication signals using the same antenna elements in antenna 104 and reject unwanted signals. Communication signals transmitted from the SDT 102 to RF receivers, such as mobile communication devices 106, can be forwarded from an SDR transceiver 120 to WLPA 108 for amplification, then through to the duplexer 105 for transmission. Each antenna array 104 can have at least one dedicated SDR transceiver 120.

The SDR transceivers 120 can preferably perform protocol translation on communication signals. As used herein, the term protocol encompasses any of a wide variety of parameters that define an existing voice or data network communications. For example, data format, timing, coding, transmission mode, modulation scheme and carrier frequencies can all be determined by the protocol definition for a particular communication system. In wireless communications protocols are defined by three layers: (1) physical layer, (2) data link layer, (3) message layer. These layers are typically incorporated into various wireless protocol standards and access methods, for example European Telecommunication Standards Institute Global System for Mobile communications (GSM), Telecommunication Industry Association TIA/EIA-2000 code division multiple access (CDMA) protocol, TIA/EIA-136 time division multiple access (TDMA) protocol, TIA/EIA-102 Land-Mobile Communications protocol, etc. Police, fire and emergency services in a particular geographic area may utilize different protocols. Notably, the present invention can be implemented to operate with any known or proprietary protocol and is not limited to any specific protocols. Further, since protocol standards can incorporate sub classes that can differ in the way layers operate, the present invention can implement protocol translation between protocol sub classes as well as to translation between protocols.

A software defined translator controller (SDTC) 110 can provide system management, control and configuration. SDTC 110 can be a computer, controller, or other device incorporating software-processing capabilities. For example, SDTC 110 can include a CPU, general-purpose microprocessor, field programmable gate array, or other processing device. SDTC 110 can also include a data communications port for communication with the software-defined translator 102, a data communications network, and a user. SDTC can also include storage medium, for example a hard disk drive, re-writable compact disk (CDRW), tape drive, compact disc drive, and random access memory (RAM). However, the embodiment of the storage medium is not so limited and other forms of information storage can be incorporated.

The SDTC 110 can monitor the SDR transceivers 120 and other aspects of the SDT 102, as well as the data communications network incorporating the SDT 102. The SDTC 110 can be at an SDT site or located remotely to the SDT 102. Further, the SDTC 110 can be connected to an interactive management interface 111 to enable a user to select and dynamically alter the operating parameters of the SDT 102. For example, a user can select transmit and receive protocols for the SDR transceivers.

Interactive interfaces are well known in the art of data communications networks. Examples of interactive interfaces are computer terminals, touch screens, personal computers, laptop computers, personal digital assistants (PDA's), telephones, etc. The interactive interface 111 can be included with the SDTC 110, connected to the SDTC 110 at the SDT site, or remotely connected to the SDTC 110. The remote connection can be wireless or via wireline. Both forms of connectivity are well known in the art of data communications networks.

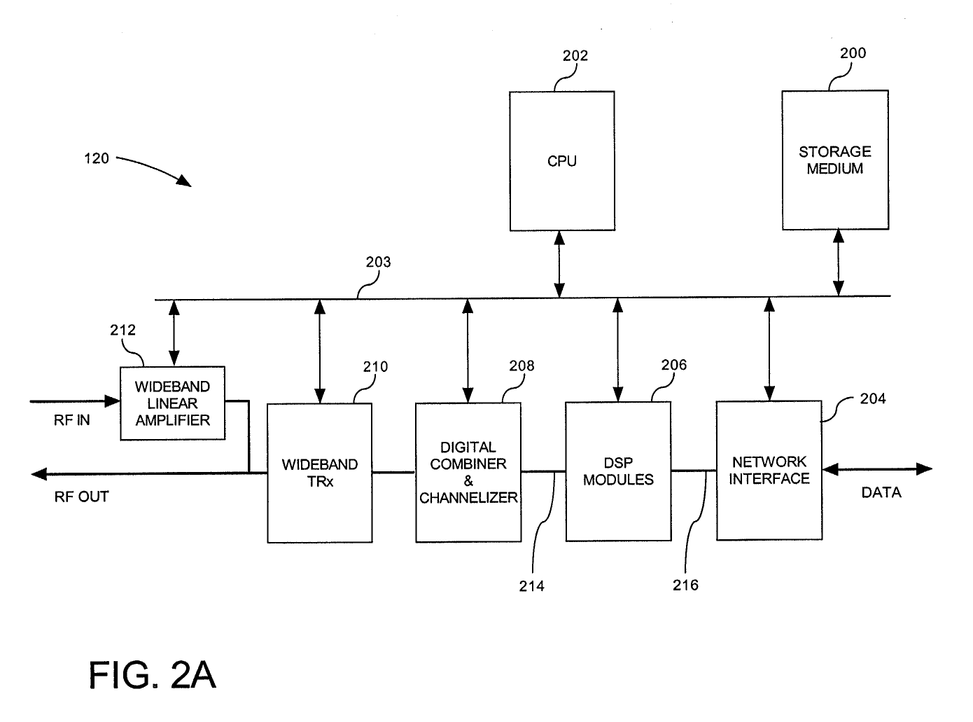

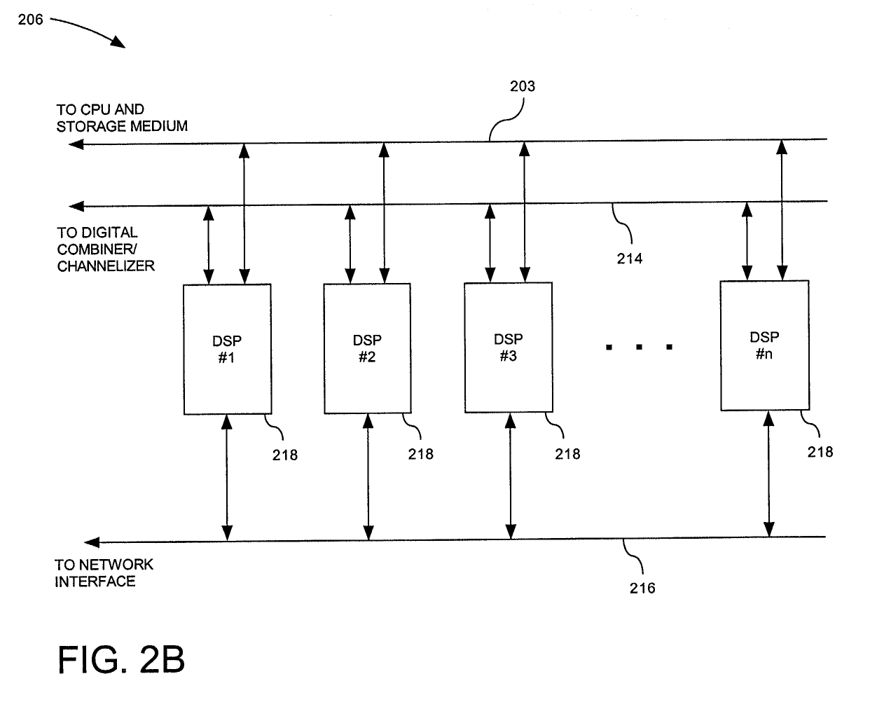

FIG. 2A is a simplified block diagram of SDR components contained in the SDR transceiver 120. SDR transceiver comprises CPU 202, digital signal processor (DSP) module 206, digital combiner/channelizer 208, wideband transmitter/receiver (TRx) 210, wideband linear amplifier 212, and storage medium 200. The basic architecture for wideband transceiver systems as described herein is well known. For example, such a system is disclosed in U.S. Pat. No. 5,535,240 to Carney et al., the disclosure of which is incorporated herein by reference. A common computer interface bus 203 can be provided to facilitate communications between CPU 202 and other SDR transceiver components. A network interface 204 can be provided to facilitate communications between the SDR transceiver 120 and other devices. For example, the network interface 204 can facilitate communication between the SDR transceiver 120 and the SDTC 110 or a second SDR transceiver. The network interface 204 also can facilitate communications between the SDR transceiver 120 and other data communication networks, for example PSTN 114 and PSPN 112.

The CPU 202 can be a programmable digital signal processor, general-purpose microprocessor, field programmable gate array, or other processing device. The storage medium 200 can include at least one common storage medium, such as a magnetic disk medium, an optical disk medium or an electronic storage medium. For example, storage medium 200 can incorporate a hard disk drive typical of those used in computer systems. Nevertheless, a re-writable compact disk (CDRW) or RAM can also be used. However, the embodiment of the storage medium is not so limited and other forms of information storage can be incorporated. Further, RAM and ROM memory can be stored in the DSP module 206 or elsewhere in the SDR transceiver.

A plurality of user selectable software protocol applications can be stored in a memory storage associated with SDTC 110 or may be downloaded by SDTC 110 from an Internet library site. Alternatively, such protocol applications can be stored in storage medium 200. In either case the user can select desired software protocol applications for each SDR transceiver 120. When instantiated in the software defined translator, the software protocol applications permit the software-defined translator to receive and/or transmit using the particular communication protocol correlating to the software protocol application. According to a preferred embodiment, the software protocol applications also include protocol translation algorithms to translate a particular communications protocol to a common protocol that can be used internally within the translator system.

CPU 202 can communicate with DSP module 206 to activate protocol translation algorithms to enable protocol translation in the DSP module. A variety of commonly used standard and proprietary protocols are preferably stored and available for user selection. When a specific protocol translation algorithm is required, the protocol translation algorithm can be transferred from SDTC 110 or data storage 200 to RAM associated with the DSP module 206 to perform protocol translation. A user can use interactive management interface 111 to update protocol translation algorithms when desired. The user can transfer the new protocol translation algorithms to the data storage over a data communications network or from SDTC 110.

In another embodiment, protocols can be downloaded and instantiated as required. For example, a DSP can monitor idle channels, detect RF signals, determine what protocols are being used by the detected RF signals based on signal characteristics, and then select the appropriate protocols. The selected protocols then can be transferred to RAM associated with the DSP modules 206 to perform protocol translation. Alternatively, detected signals can be routed to DSPs that already have the appropriate protocols loaded. Security codes can be encoded into desired RF signals to enable an SDR transceiver to reject unwanted signals not having an appropriate security code. Further, an SDR transceiver can be predisposed to ignore signals having certain characteristics.

FIG. 2B shows individual DSPs 218 contained in DSP module 206. An individual DSP can be allocated for processing a received communication signal and an individual DSP can be allocated for processing a communication signal that is to be transmitted. The individual DSPs 218 can communicate with the CPU 202 and storage medium 200 via the common computer interface bus 203. Further, the individual DSPs 218 can communicate with the digital combiner/channelizer with a common combiner/channelizer bus 214 and the DSPs 218 can communicate with the network interface via a common network interface bus 216. The common network interface bus 216 can also be used by the individual DSPs to communicate with each other. Alternatively, a dedicated DSP bus can be provided for communication between the individual DSPs.

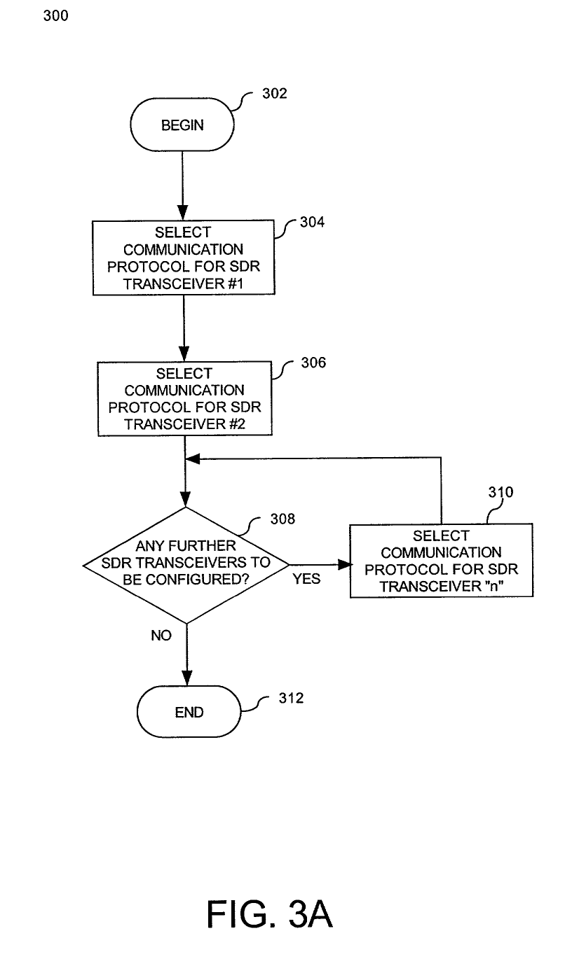

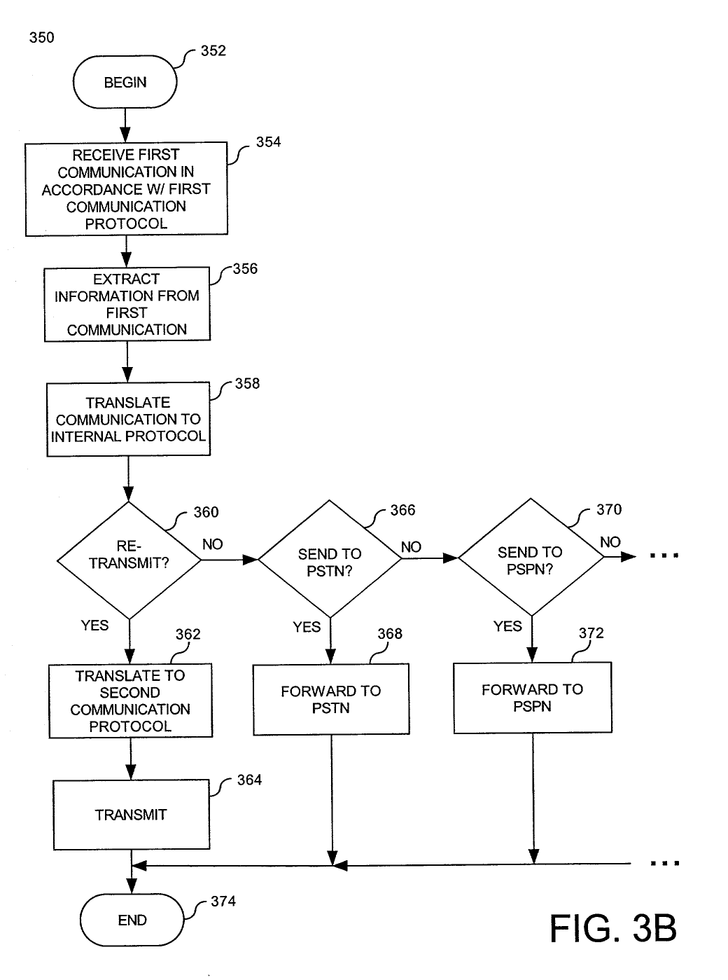

Referring to FIG. 3A, the protocol translation activation process is shown in flow chart 300. The process begins at step 302. A user can select a first communication protocol for use by SDR transceiver #1, as shown in step 304. The user can use the management interface 111 to make the protocol selection. For example, a list of available protocol translation algorithms can be displayed to the user for the user to choose from and the user can enter a selection into the management interface 111. Referring to step 306, the user can select a second communication protocol for SDR transceiver #2 in the same manner.

Referring to decision block 308, a user can choose to re-transmit a received signal on more than two SDR transceivers. Hence, a communication protocol can be selected for any additional transceivers that will be used, as shown in step 310. Additional transmit protocols can be selected as desired for re-transmitting the received signal. Communication protocols applications selected for facilitating a communication link between communications devices or systems are defined herein to be correlating communication protocol applications.

After the communication protocols are selected, SDTC 110 can complete the protocol translation activation process by dynamically loading to the storage medium 200 the correlating communication protocol applications. The protocol translation algorithms then can be instantiated by CPU 202 for use by DSP modules 206. In this way, the protocol translation algorithms can be implemented quickly and easily to enable an SDT 102 to be rapidly configured in the event of an emergency or military deployment.

Referring to FIG. 3B, a flowchart 350 for the operation of an SDT 102 incorporating protocol translation for selected software defined radio transceivers is shown. The process begins at step 352. Referring to step 354, a first antenna 104 can receive a first RF communication signal from a signal source, for example a mobile communication device 106 or a repeater, and forward the communication signal to a first SDR transceiver 120 via the duplexer 105. Typically an array is designed to operate in a specific frequency range. Hence, an array 104 can be provided for each frequency range that SDT 102 is required to operate in. Nevertheless, one or more wideband antenna arrays can also be used for operation in multiple frequency ranges.

The first SDR transceiver 120 can receive the first communication signal from the duplexer 105 and extract the voice or data information from the first communication signal, as shown in step 356. The first SDR transceiver 120 can then translate the first communication signal to an internal protocol, as shown in step 358. The internal protocol can be a common baseband protocol. A software algorithm can be used by DSP module 206 to implement the translation process. Referring to decision block 360, if the communication signal is to be re-transmitted through a transceiver, the communication signal then can be forwarded to a second SDR transceiver 120 over a dedicated transmit and receive bus 122.

The second SDR transceiver can again implement a software algorithm to translate the communication signal to a second communication protocol, as shown in step 362. The second SDR transceiver 120 can then forward the signal to a wideband linear power amplifier (WLPA) 108 for amplification. After amplification the signal can be forwarded to the duplexer 105, then to an array 104 for RF transmission. A communication signal receiver, for example a mobile communication device 106 or a repeater, can receive the transmitted communications signal.

In an alternate embodiment, a communication signal can be received and transmitted from the same SDR transceiver. For example, if a transmitting mobile communication device 106 and a receiving mobile communication device 106 both operate in a transceiver's operational frequency range and both devices are located in an area serviced by an SDR transceiver.

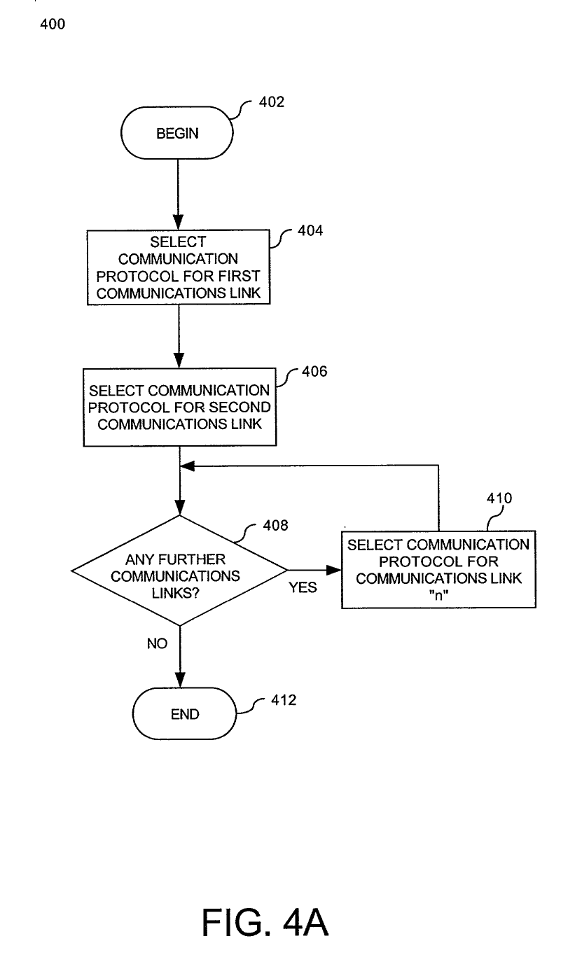

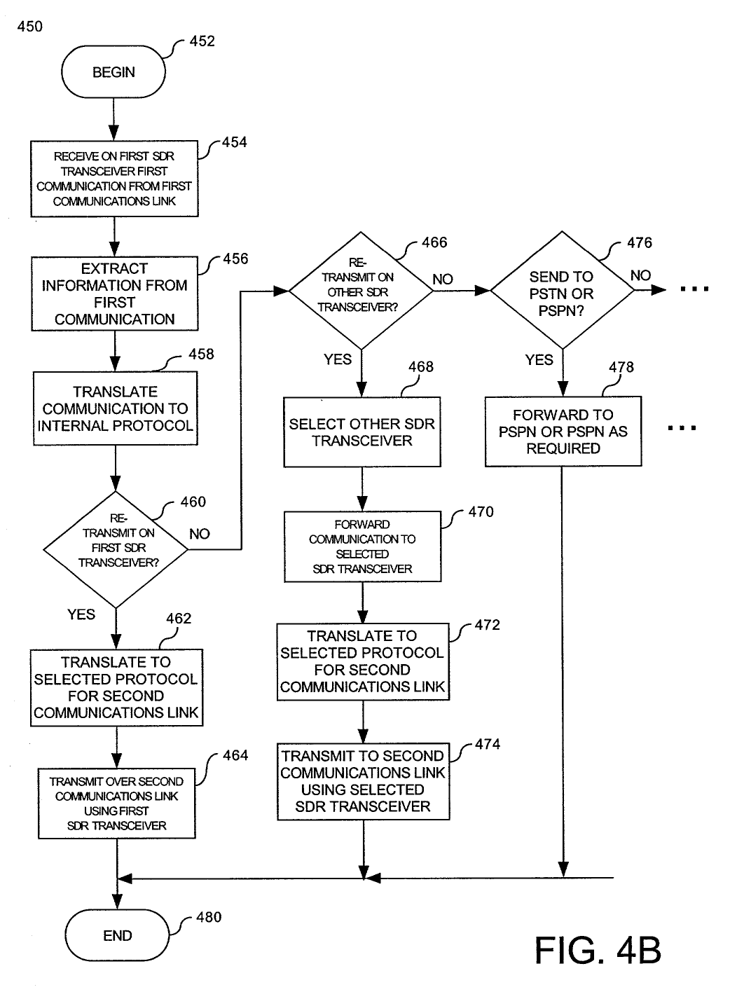

Referring to FIG. 4A, a flow chart 400 for selecting protocols for communications links is shown. The process begins at step 402. Referring to step 404, a user can select a correlating communication protocol application for a first communications link. For example, the first communications link can be established for communications with a first mobile communication device 106. Referring to step 406, the user can also select a correlating communication protocol application for the second communications link, for example with a second mobile communication device 106. The user can use the management interface 111 to make the protocol selections, as previously discussed. Referring to decision block 408 and step 410, a user can also select additional correlating communication protocols applications for additional communications links. For example, a user may enable a first mobile communication device 106 operating with a first communications protocol to communicate with multiple other communication devices operating with the same or differing protocols.

Referring to FIG. 4B, a flowchart 450 for the operation of an SDT 102 incorporating protocol translation for selected communication links is shown. The process begins at step 452. Referring to step 454, a first communication signal over a first communications link can be received on a first SDR transceiver. The received voice or data information can be extracted from the first communication signal using a first DSP 218. The DSP 218 also can translate the communication signal to an internal protocol, as shown in step 458. For example, a common baseband protocol.

Referring to decision block 460, a decision can be made by a user, or by CPU 202 following a transmission allocation algorithm, to re-transmit the communication signal on the first SDR transceiver. This can be advantageous if a first communication device is communicating with a second communication device in a region covered by the first SDR transceiver. Of course, for both the first and second communication devices to operate on the same SDR transceiver, the communication devices should be operating within the frequency range the first SDR transceiver operates. Nevertheless, wideband SDR transceivers can operate over broad frequency ranges, that facilitates the use of SDR transceivers to communicate with multiple communication devices operating with different communications protocols.

Referring to step 462, the first DSP 218 can forward the communication signal to a second DSP 218 to translate the communication signal to a second protocol selected for the second communications link. DSPs 218 can communicate with each other via the common network interface bus 216. Alternatively, DSPs 218 can communicate with each other via the common combiner/channelizer bus 214 or the common computer interface bus 203. Referring to step 464, after translation to the second protocol, the communication signal can be processed by digital combiner & channelizer 208, wideband transceiver 210 and WLPA 108 for transmission over the second communications link. Similar processing is used for communications signals received over the second communication link for transmission over the first communication link. Further, received communications signals can be similarly processed for transmission over other communications links as well.

If a first mobile communications device 106 and a second mobile communications device 106 are located in areas serviced by different transceivers, then after the first communications signal has been translated to an internal protocol, the first communications signal can be transmitted by a second SDR transceiver, as shown in decision block 466. Referring to step 468, the second SDR transceiver can be selected by a user or by CPU 202 following a transmission allocation algorithm. The first communications signal can be forwarded to the second SDR transceiver as shown in step 470, and the first communications signal can be translated by the SDR transceiver 120 to a protocol selected for the second communication link and transmitted, as shown in steps 472 and 474.

Although the second SDR transceiver 120 shown in FIG. 1 is a component of the SDT 102, the second SDR transceiver 120 can also be installed in another SDT, so long as there is some form of communication link between the first SDR transceiver 120 and the second SDR transceiver 120. The communication link between the first and second transceivers can be over wire or wireless. For example, the communication signal can be forwarded to a PSTN 114 or PSPN 112, as shown in decision block 476 and step 478, and then forwarded to the second SDR transceiver 120. After the second SDR transceiver 120 has translated the communication signal to a desired protocol, the second SDR transceiver 120 can then forward the communication signal for transmission. Further, PSTN 114 and PSPN 112 can forward the signal to conventional wireline communications devices as well.

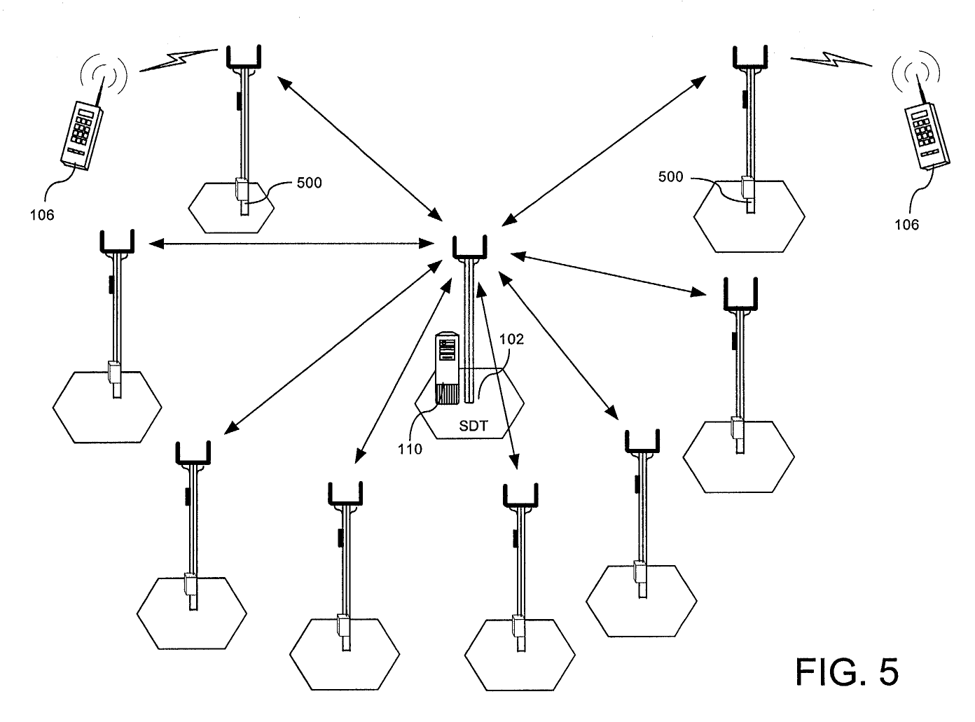

Referring to FIG. 5, repeaters 500 can be placed in regions outside the reach of an SDT's ground link, the communication channel between a communication unit and an SDT 102. By itself, an SDT 102 can only cover a limited area with ground links. Hence, the repeaters 500 are used to expand the range of the SDT 102 to cover additional regions. These regions are referred to in the art as cells. The repeaters can be stationary or can be mobile. For example, the repeaters can be mounted to vehicles, trains, boats or aircraft.

In operation, a first repeater 500 can receive from a mobile communication device 106 a communication signal transmitted using a first protocol. The first repeater 500 can translate the signal carrier frequency from the ground link frequency to a backhaul frequency, the frequency used for communications between the repeater 500 and the SDT 102. The repeater can then forward the signal to an SDT 102. SDT 102 can translate the signal from the first protocol to a second protocol. Further, SDT 102 can retransmit the signal over a backhaul frequency to the same repeater, a second repeater, or multiple ones of repeaters 500. Any of such repeaters can then translate the carrier frequency to a ground link frequency and forward the communication signal to second mobile repeater 106.

In an alternate embodiment, repeaters 500 can be software defined radio translators that translate a communication signal received from mobile communication device 106. For example, a repeater 500 can translate the communication signal from a first protocol to a common protocol and transmit the communication signal to a base station in the common protocol format. Likewise, the repeater 500 can receive a communication signal from the base station in the common protocol format and translate the communication signal from the common protocol to the first protocol. The repeater then can transmit the communication signal to the mobile communication device 106.

It should be understood that the examples and embodiments described herein are for illustrative purposes only and that various modifications or changes in light thereof will be suggested to persons skilled in the art and are to be included within the spirit and purview of this application. The invention can take many other specific forms without departing from the spirit or essential attributes thereof for an indication of the scope of the invention.

1. In a communications environment comprised of a plurality of communications systems, each having a distinct communications protocol associated therewith, a method for facilitating inter-system communications using a software defined translator, comprising:
selecting from among a plurality of predefined software communication protocol applications available in the software-defined translator, a plurality of correlating communication protocols applications respectively corresponding to a plurality of the communications protocols in use by said communication systems;
instantiating said plurality of correlating communication protocol applications in said software defined translator;
receiving a first communication transmitted by a first one of said plurality of communication systems corresponding to a first one of said plurality of communications protocols;
translating said first communication to at least a second one of said plurality of communications protocols; and
re-transmitting said first communication after said translation step.

2. The method according to claim 1 wherein said translating step further comprises translating said first communication to a common protocol prior to translation to said second one of said plurality of communications protocols.

3. The method according to claim 1 wherein at least one of said plurality of communications systems comprises a mobile communication device.

4. The method according to claim 1 wherein said first communication is translated to a plurality of said communications protocols in use by said communications systems.

5. The method according to claim 1 wherein each of said communications protocols is comprised of at least one of a data format, data timing system, coding scheme, transmission mode, and carrier frequency.

6. The method according to claim 1 wherein said receiving step is further comprised of receiving said first communication at a repeater station and forwarding said first communication to said software defined translator.

7. The method according to claim 1 wherein said re-transmitting step is further comprised of forwarding said first communication to a repeater station for said retransmitting.

8. The method according to claim 1 further comprising the step of backhauling said first communication from said software defined translator to a base station prior to said re-transmitting step.

9. The method according to claim 8 further comprising the step of forwarding said first communication from said base station to a second software defined translator prior to said re-transmitting step.

10. A software defined translator system for facilitating inter-system communications in a communications environment comprised of a plurality of communications systems, each having a distinct communications protocol associated therewith, said software defined translator comprising:
an interactive management interface responsive to a user input for instantiating in a software defined translator a plurality of correlating communication protocol applications respectively corresponding to a plurality of said communications protocols in use by said communication systems; and
said software defined translator system responsive to a first communication transmitted by a first one of said plurality of communications systems in accordance with a first one of said plurality of communications protocols, for translating said first communication to at least a second one of said plurality of communication protocols, and re-transmitting said first communication after said translation.

11. The software defined translator system according to claim 10 wherein said at least one software defined translator translates said first communication to a common protocol prior to translation to said second one of said plurality communications protocols.

12. The software defined translator system according to claim 10 wherein at least one of said plurality of communications systems comprises a mobile communication device.

13. The software defined translator system according to claim 10 wherein said software defined translator translates said first communication to a plurality of said communications protocols.

14. The software defined translator system according to claim 13 further comprising means for retransmitting said first communication in accordance with each said plurality of communications protocols.

15. The software defined translator system according to claim 10 wherein each said communications protocol is comprised of at least one of a data format, data timing system, coding scheme, transmission mode, and carrier frequency.

16. The software defined translator system according to claim 10 further comprising a repeater station for receiving said first communication and forwarding said first communication over a backhaul link to said software defined translator.

17. The software defined translator system according to claim 10 further comprising a repeater station for receiving said first communication from said software defined translator over a backhaul link after said first communication has been translated, and re-transmitting said first communication.

18. The software defined translator according to claim 10 further comprising a backhaul link for backhauling said first communication from said software defined translator to a base station prior to said retransmitting.

19. The software defined translator according to claim 18 further comprising a second backhaul link for backhauling said first communication from said base station to a second translator prior to said re-transmitting.
